(19) United States
(12) Patent Application Publication
(10) Pub. No.: US 2021/0125184 A1
(43) Pub. Date: Apr. 29, 2021

(54) BIOMETRIC PAYMENT SYSTEM THAT INTELLIGENTLY OPTIMIZES PAYMENT TRANSACTIONS

(71) Applicant: Alclear, LLC, New York, NY (US)

(72) Inventor: Joe Trelin, New York, NY (US)

(21) Appl. No.: 16/661,073

(22) Filed: Oct. 23, 2019

(51) Int. Cl. G06Q 20/40; G06Q 20/24; G06Q 20/26; G06Q 30/02

(52) U.S. Cl. CPC G06Q 20/40145; G06Q 30/0226; G06Q 20/26; G06Q 20/24

(57) ABSTRACT

A biometric payment system intelligently optimizes one or more transactions. The system may receive one or more digital representations of one or more biometrics for one or more people, access associated identity information, and use the identity information to optimize one or more transactions. This optimization may involve determining one or more payment methods that minimize a cost of the transaction, determining one or more payment methods that maximize a reward for the transaction, determining one or more loyalty programs to minimize cost and/or maximize reward for the transaction, and so on.

### FIELD

The described embodiments relate generally to biometric payment systems. More particularly, the present embodiments relate to biometric payment systems that intelligently optimize transactions.

### BACKGROUND

People use a variety of different payment methods to pay for transactions. For example, people may use multiple different credit cards, debit cards, checking accounts, savings accounts, and so on. People may even use rewards associated with a loyalty program, such as airline miles associated with an airline loyalty program, to pay for transactions.

People also use a variety of different loyalty accounts with transactions. For example, a person may use an airline loyalty program or a rental agency loyalty program when engaging in a vehicle rental transaction. Use of the airline loyalty program or the rental agency loyalty program with the vehicle rental transaction may accumulate points that the person may redeem for rewards, may qualify the person for special tiers of service or discounts, and so on.

### SUMMARY

The present disclosure relates to a biometric payment system that intelligently optimizes transactions. The system may receive one or more digital representations of one or more biometrics for one or more people, access associated identity information, and use the identity information to optimize one or more transactions. This optimization may involve determining one or more payment methods that minimize a cost of the transaction, determining one or more payment methods that maximize a reward for the transaction, determining one or more loyalty programs to minimize cost and/or maximize reward for the transaction, and so on.

In various embodiments, a biometric payment system that intelligently optimizes transactions includes at least one non-transitory storage medium that stores instructions and at least one processing unit. The at least one processing unit executes the instructions to receive a digital representation of a biometric for a person in association with a transaction, access identity information for the person using the digital representation of the biometric, retrieve multiple payment methods from the identity information, use at least the identity information to determine a set of the multiple payment methods for the transaction that minimizes a cost to the person, and facilitate payment for the transaction using the set of the multiple payment methods.

In some examples, the set of the multiple payment methods includes one of the multiple payment methods. In other implementations, the set of the multiple payment methods includes a combination of the multiple payment methods. In various examples, the multiple payment methods includes at least one of a credit card identifier, a debit card identifier, an airline miles account identifier, a savings account identifier, a checking account identifier, an investment account identifier, cryptocurrency, or a loyalty account identifier.

In a number of examples, the at least one processing unit facilitates the payment for the transaction by providing the set of the multiple payment methods to a merchant device associated with the transaction. In some examples, the at least one processing unit facilitates the payment for the transaction by processing the payment using the set of the multiple payment methods. In a number of examples, the at least one processing unit facilitates the payment for the transaction by submitting at least a portion of the set of the multiple payment methods to at least one payment processing device.

In some embodiments, a biometric payment system that intelligently optimizes transactions includes at least one non-transitory storage medium that stores instructions and at least one processing unit. The at least one processing unit executes the instructions to receive a digital representation of a biometric for a person in association with a transaction, access identity information for the person using the digital representation of the biometric, retrieve multiple payment methods from the identity information, use at least the identity information to determine a set of the multiple payment methods for the transaction that maximizes a reward for the person for using the set of the multiple payment methods, and facilitate payment for the transaction using the set of the multiple payment methods.

In various examples, the at least one processing unit receives transaction details for the transaction and uses the transaction details and the identity information to determine the set of the multiple payment methods. In some implementations of such examples, at least one of the multiple payment methods provides variable rewards corresponding to different transaction details.

In a number of examples, the at least one processing unit receives payment method information from at least one payment method provider associated with at least one of the multiple payment methods and uses the payment method information and the identity information to determine the set of the multiple payment methods. In various examples, the reward includes at least one of a cash back program benefit, a loyalty reward point, a rewards tier increment, or a discount.

In some examples, the at least one processing unit facilitates the payment for the transaction by communicating with at least one payment method provider associated with at least one of the set of the multiple payment methods. In various implementations of such examples, the at least one processing unit provides information regarding the transaction to the at least one payment method provider.

In a number of embodiments, a biometric payment system that intelligently optimizes transactions includes at least one non-transitory storage medium that stores instructions and at least one processing unit. The at least one processing unit executes the instructions to receive a digital representation of a biometric for a person in association with a transaction, access identity information for the person using the digital representation of the biometric, retrieve multiple loyalty programs from the identity information, use at least the identity information to determine a loyalty program of the multiple loyalty programs to use for the transaction that optimizes the transaction for the person, and facilitate use of the loyalty program for the transaction.

In some examples, the loyalty program of the multiple loyalty programs is a first loyalty program, the multiple loyalty programs include a second loyalty program, and the first loyalty program optimizes the transaction for the person by resulting in a lower cost than the second loyalty program. In various examples, the loyalty program of the multiple loyalty programs is a first loyalty program, the multiple loyalty programs include a second loyalty program, and the first loyalty program optimizes the transaction for the person by resulting in a greater reward than the second loyalty program.

In a number of examples, the at least one processing unit facilitates payment for the transaction. In some examples, the at least one processing unit maintains the loyalty program for a loyalty program provider. In various examples, the at least one processing unit enrolls the person in the loyalty program.

### BRIEF DESCRIPTION OF THE DRAWINGS

The disclosure will be readily understood by the following detailed description in conjunction with the accompanying drawings, wherein like reference numerals designate like structural elements.

FIG. 1 depicts a first example of a biometric payment system that intelligently optimizes transactions.

FIG. 2 is a flow chart illustrating a first example method for intelligently optimizing transactions using a biometric payment system. This method may be performed by the system of FIG. 1.

FIG. 3 is a flow chart illustrating a second example method for intelligently optimizing transactions using a biometric payment system. This method may be performed by the system of FIG. 1.

FIG. 4 is a flow chart illustrating a third example method for intelligently optimizing transactions using a biometric payment system. This method may be performed by the system of FIG. 1.

FIG. 5 is a flow chart illustrating a fourth example method for intelligently optimizing transactions using a biometric payment system. This method may be performed by the system of FIG. 1.

FIG. 6 is a flow chart illustrating a fifth example method for intelligently optimizing transactions using a biometric payment system. This method may be performed by the system of FIG. 1.

FIG. 7 is a flow chart illustrating a sixth example method for intelligently optimizing transactions using a biometric payment system. This method may be performed by the system of FIG. 1.

FIG. 8 is a flow chart illustrating a seventh example method for intelligently optimizing transactions using a biometric payment system. This method may be performed by the system of FIG. 1.

FIG. 9 is a flow chart illustrating an eighth example method for intelligently optimizing transactions using a biometric payment system. This method may be performed by the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Different payment methods may be associated with different costs for the person. For example, a fee may be charged for some payment methods (such as credit cards) for a transaction. Such a fee may cause the respective payment method to cost the person more to use for that particular transaction than another payment method that does not have such a fee. By way of another example, some payment methods may be entitled to discounts for particular transactions, such as an airline credit card being entitled to a discount on air travel tickets. Such a discount may cause the respective payment method to cost the person less to use for that particular transaction than another payment method that does not provide such a reward. In yet another example, some payment methods may correspond to an item with a variable value (such as cryptocurrency, an investment account, and so on). The cost associated with using the respective payment method may correspond to the current value and/or other factors such as an original purchase cost, expected value performance, brokerage fees for redeeming the item, and so on.

Further, some payment methods may be associated with one or more rewards, such as a cash back reward where money is earned through use of a credit card or other payment method for payment. This may change the effective cost to the person for the transaction as the reward may offset part or all of the cost. Separate from cost, different payment methods may be associated with different rewards for the person.

Additionally, different loyalty programs may be associated with different costs or rewards for the person. In some examples, such loyalty programs may be one or more of the payment methods discussed above. In other examples, one or more loyalty programs used with a transaction may be separate from any payment method involved.

The following disclosure relates to a biometric payment system that intelligently optimizes transactions. The system may receive one or more digital representations of one or more biometrics for one or more people, access associated identity information, and use the identity information to optimize one or more transactions. This optimization may involve determining one or more payment methods that minimize a cost of the transaction, determining one or more payment methods that maximize a reward for the transaction, determining one or more loyalty programs to minimize cost and/or maximize reward for the transaction, and so on.

In this way, the system may be operable to arbitrage and/or otherwise optimize the transaction for one or more different payment methods and/or loyalty programs in one or more different ways. This may allow the system to perform functions that the system was not previously able to perform, as well as improving the efficiency and operation of the system by reducing duplicate data storage and/or other equipment, decreasing processor and/or network traffic burden, and so on. For example, the system may allow use of different payment methods and/or loyalty programs such that the person does not need to provide the information repeatedly, making the system easier for the person to use and reducing network traffic and system resource consumption that would otherwise be used for such data exchange. Further, the system improves the field of data security by verifying identity associated with payment methods and/or loyalty programs and by reducing the amount of sensitive information transmitted across one or more networks.

Additionally, a person attempting to optimize the transaction may enter different combinations of payment methods and/or loyalty programs, perform various related calculations, observe results, change combinations to determine changed results, and so on. In addition to removing the burden from the person to perform such operations in order to optimize the transaction, the above system may improve operation and response time by eliminating the processing, data communication, and/or other resource consumption associated with these activities as well as eliminating components used for such activities.

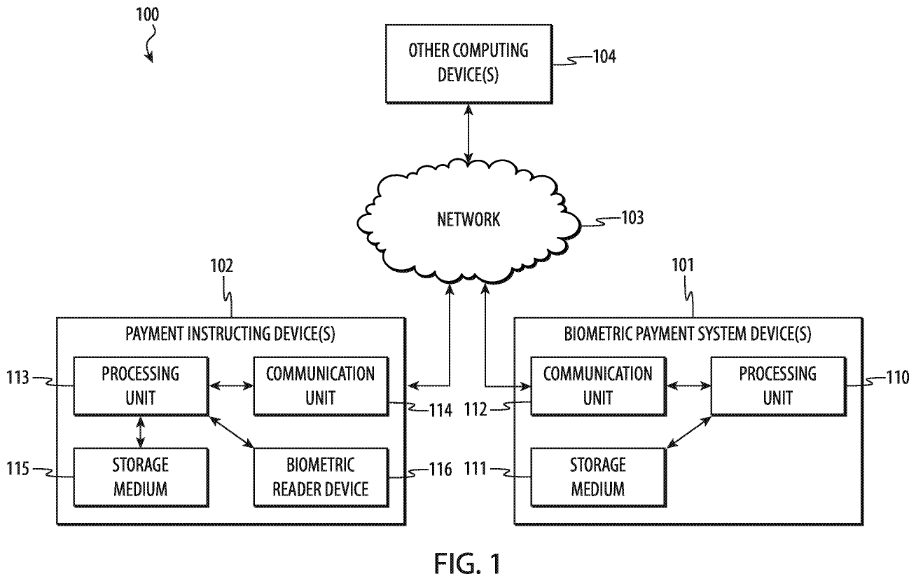

These and other embodiments are discussed below with reference to FIGS. 1-9. However, those skilled in the art will readily appreciate that the detailed description given herein with respect to these Figures is for explanatory purposes only and should not be construed as limiting.

FIG. 1 depicts a first example of a biometric payment system 100 that intelligently optimizes transactions. The system 100 may include one or more biometric payment system devices 101 that are operable to communicate with one or more payment instructing devices 102 and/or other devices (such as one or more other computing devices 104) via one or more networks 103. The system 100 may use one or more of these components to optimize one or more transactions for one or more people.

In the context of the present disclosure, “optimize” may refer to a way of configuring the transaction that fits a goal for the transaction over other possible options. For example, such a configuration may involve determining a set of payment methods to use for a transaction that minimizes costs over other possible sets of payment methods. By way of another example, such a configuration may involve determining a set of payment methods to use for a transaction that maximizes rewards over other possible sets of payment methods. In yet another example, such a configuration may involve determining a loyalty program from multiple loyalty programs to use for the transaction that results in a lower cost than other loyalty programs of the multiple loyalty programs, higher rewards than other loyalty programs of the multiple loyalty programs, and so on. However, it is understood that these are examples and are not intended to be limiting.

The biometric payment system device 101 may receive one or more digital representations of one or more biometrics for one or more people from the payment instructing device 102. The biometric payment system device 101 may use the digital representation of the biometric to access associated identity information and may use the identity information to optimize one or more transactions. This optimization may involve determining one or more payment methods that minimize a cost of the transaction, determining one or more payment methods that maximize a reward for the transaction, determining one or more loyalty programs to minimize cost and/or maximize reward for the transaction, and so on. Various configurations are possible and contemplated without departing from the scope of the present disclosure.

In various implementations, the biometric payment system device 101 may receive a digital representation of a biometric for a person in association with a transaction, access identity information for the person using the digital representation of the biometric, retrieve multiple payment methods from the identity information, and use at least the identity information to determine a set of the multiple payment methods for the transaction that minimizes a cost to the person. The biometric payment system device 101 may facilitate payment for the transaction using the set of the multiple payment methods.

In some examples, the set of multiple payment methods may include one of the multiple payment methods. In other examples, the set of multiple payment methods may include a combination of the multiple payment methods. In various examples, the multiple payment methods may include at least one of a credit card identifier (such as a credit card number), a debit card identifier (such as a debit card number), an airline miles account identifier, a savings account identifier, a checking account identifier, an investment account identifier, cryptocurrency, a loyalty account identifier, and so on.

For example, the multiple payment methods may include a credit card and an airline miles account. The biometric payment system device 101 may determine that the airline miles account includes rewards points or other rewards program that may be used for part or all of a transaction. The biometric payment system device 101 may determine that use of the airline miles account for part or all of the transaction would result in a lower cost for the person than the credit card as the person would be later billed money for use of the credit card. As such, the biometric payment system device 101 may minimize the cost by generating a set of the multiple payment methods that includes the airline miles account. If the airline miles account can be used for only a part of the transaction, the biometric payment system device 101 may generate the set of the multiple payment methods as including the amount available using the airline miles account and the remainder using the credit card.

By way of another example, the multiple payment methods may include a credit card and a checking account. The biometric payment system device 101 may determine that there is a fee associated with use of the credit card. As such, the biometric payment system device 101 may minimize the cost by generating a set of the multiple payment methods including the checking account.

In a third example, the multiple payment methods may include multiple different credit cards. Each of the multiple different credit cards may have a different interest rate. As such, the biometric payment system device 101 may generate a set of the multiple payment methods including the credit card of the multiple different credit cards that has the lowest interest rate.

In a fourth example, the multiple payment methods may include a credit card and a savings account. The credit card may have an associated interest rate, but may also be associated with a rewards program. Further, interest may only be charged if the credit card has a balance more than one billing cycle. The biometric payment system device 101 may access stored information regarding the person's past use of the multiple payment methods and determine that the person typically pays the full balance on the credit card each billing cycle. As such, the biometric payment system device 101 may determine that the interest will not accrue and that the credit card is either equivalent in cost to the savings account or lower if the rewards are taken into account. Thus, the biometric payment system device 101 may generate the set of the multiple payment methods including the credit card. Alternatively, the biometric payment system device 101 may generate the set of the multiple payment methods including the credit card in order to obtain the rewards for the person and then use the savings account to pay the corresponding balance on the credit card to ensure that the interest will not accrue.

In a fifth example, the multiple payment methods may include a first credit card that is eligible for a discount on the transaction and a second credit card that is not eligible for the discount. By way of illustration, an airline credit card may be eligible for discounts when used for buying flights on that airline. As such, the biometric payment system device 101 may generate the set of the multiple payment methods including the first credit card.

In a sixth example, the multiple payment methods may include a credit card and a debit card. The credit card may have an associated interest rate whereas the debit card may not, but the credit card may be associated with a rewards tier where a person is entitled to discounts and/or other benefits or rewards after a certain amount of usage per year. The person may be close to the rewards tier and the biometric payment system device 101 may determine that benefits available from achieving the rewards tier will outweigh the interest. As such, the biometric payment system device 101 may generate the set of the multiple payment methods including the credit card.

In a seventh example, the multiple payment methods may include a credit card and a loyalty account. The loyalty account may include rewards points that are available to pay for the transaction and may thus be a lower cost than the credit card as the credit card may cost the person money upon billing. However, the rewards points may have a variable value such that they are worth more upon accumulating certain levels (such as 1000 rewards points being redeemable for more than two individual redemptions of 500 rewards points each). The biometric payment system device 101 may determine that the cost saved by using the loyalty account versus the credit card would be outweighed by saving the rewards points until more are accumulated. As such, the biometric payment system device 101 may generate the set of the multiple payment methods including the credit card.

In various examples, the biometric payment system device 101 may facilitate the payment for the transaction by providing the set of the multiple payment methods to one or more merchant devices associated with the transaction. In such an example, the merchant device may then process the payment using the set of the multiple payment methods and/or provide the set of the multiple payment methods to one or more payment processors. In other examples, the biometric payment system device 101 may facilitate the payment by processing the payment using the set of the multiple payment methods and/or providing the set of the multiple payment methods to one or more payment processors to process payment. Various configurations are possible and contemplated without departing from the scope of the present disclosure.

In some implementations, the biometric payment system device 101 may receive a digital representation of a biometric for a person in association with a transaction, access identity information for the person using the digital representation of the biometric, retrieve multiple payment methods from the identity information, and use at least the identity information to determine a set of the multiple payment methods for the transaction that maximizes a reward for the person for using the set of the multiple payment methods. The biometric payment system device 101 may facilitate payment for the transaction using the set of the multiple payment methods.

The rewards may include at least one of a cash back program benefit, a loyalty reward point, a rewards tier increment, a discount, and so on. In some examples, multiple different rewards may be associated with one or more of the payment methods.

For example, the multiple payment methods may include multiple credit cards that each include different cash back programs. The biometric payment system device 101 may maximize the rewards by selecting the credit card with the highest cash back program.

In various examples, the biometric payment system device 101 may receive transaction details for the transaction. The biometric payment system device 101 may use the transaction details and the identity information to determine the set of the multiple payment methods. In some of these examples, one of the multiple payment methods provides variable rewards corresponding to different transaction details. By way of illustration, a credit card may provide 5% cash back for most purchases, but 15% cash back for groceries or gasoline. As such, the biometric payment system device 101 may receive transaction details for the transaction in order to determine whether or not groceries or gasoline are involved in the transaction so that the biometric payment system device 101 may determine whether or not to evaluate the 5% cash back reward or the 15% cash back reward is applicable for the credit card.

In some examples, the biometric payment system device 101 may receive payment method information from at least one payment method provider associated with at least one of the multiple payment methods. The biometric payment system device 101 may use the payment method information and the identity information to determine the set of the multiple payment methods. By way of illustration, the payment method information may include details of rewards programs associated with the respective payment method, costs associated with the respective payment method, mechanisms for processing payments using the respective payment method, and so on.

In various examples, the biometric payment system device 101 may facilitate payment for the transaction by communicating with at least one payment method provider associated with at least one of the multiple payment methods. By way of illustration, the biometric payment system device 101 may provide information regarding the transaction to the at least one payment method provider and the at least one payment provider may process payment for at least a portion of the transaction accordingly.

In a number of implementations, the biometric payment system device 101 may receive a digital representation of a biometric for a person in association with a transaction, access identity information for the person using the digital representation of the biometric, retrieve multiple loyalty programs from the identity information, and use at least the identity information to determine a loyalty program of the multiple loyalty programs to use for the transaction that optimizes the transaction for the person. The biometric payment system device 101 may use of the loyalty program for the transaction.

By way of example, the transaction may be a vehicle rental transaction with which the person is eligible to use either an airline loyalty program or a rental agency loyalty program, but not both. Use of the airline loyalty program or the rental agency loyalty program with the vehicle rental transaction may accumulate points that the person may redeem for rewards, may qualify the person for special tiers of service or discounts, and so on. The biometric payment system device 101 may determine that the terms of the airline loyalty program and the rental agency loyalty program indicate that the person would incur a lower cost, earn more rewards, and/or otherwise optimize the transaction more by using the airline loyalty program instead of the rental agency loyalty program. As such, the biometric payment system device 101 may determine to use the airline loyalty program for the transaction instead of the rental agency loyalty program in order to optimize the transaction for the person.

In some examples, the multiple loyalty programs may include a first loyalty program and a second loyalty program. The biometric payment system device 101 may determine that the first loyalty program optimizes the transaction for the person by resulting in a lower cost than the second loyalty program. For example, the first loyalty program may enable a discount for the transaction that is not enabled by the second loyalty program. As such, the biometric payment system device 101 may determine to use the first loyalty program for the transaction to optimize the transaction for the person.

Alternatively, the biometric payment system device 101 may determine that the first loyalty program optimizes the transaction for the person by resulting in a greater reward than the second loyalty program. For example, the first loyalty program may earn rewards points for the transaction redeemable for items valued at $10 whereas the second loyalty program may earn rewards points for the transaction redeemable for items valued at $5. As such, the biometric payment system device 101 may determine to use the first loyalty program for the transaction to optimize the transaction for the person.

In various examples, the biometric payment system device 101 may also facilitate payment for the transaction in addition to using the loyalty program for the transaction. In some such examples, the biometric payment system device 101 may facilitate payment in one or more ways discussed above that optimizes the transaction for the person.

In some examples, the biometric payment system device 101 may maintain the loyalty program for a loyalty program provider. By way of illustration, the biometric payment system device 101 may store information related to the person's participation in the loyalty program, transactions related to the loyalty program, rewards earned and/or redeemed as part of the loyalty program, and so on.

In a number of examples, one or more of the multiple loyalty programs may be a loyalty program that the person is not enrolled in. In such a situation, the biometric payment system device 101 may enroll the person in the loyalty program, offer to enroll the person in the loyalty program, and so on. Various configurations are possible and contemplated without departing from the scope of the present disclosure.

In various example, a payment method provider, loyalty program provider, and/or other provider may provide a benefit for using the payment method, loyalty program, or other account or program through the biometric payment system 100 that may not be available otherwise. Such a provider may provide the benefit for use via the biometric payment system 100 as this may biometrically and/or otherwise verify the person (particularly when verifying that the person is associated with an authenticated identity) using the payment method, loyalty program, or other account or program. This may reduce fraud, error, and/or other issues that may represent an expense for the provider. As such, the providers may reward the reduced expense enabled by the reduced fraud, error, and/or other issues through use of the biometric payment system 100 by providing the benefit. In some examples, the provider may also reward and/or otherwise subsidize a provider of the biometric payment system 100 for the reduced expense enabled by the reduced fraud, error, and/or other issues through use of the biometric payment system 100. Various configurations are possible and contemplated without departing from the scope of the present disclosure.

The biometric payment system device 101 may be any kind of electronic device and/or cloud and/or other computing arrangement. Examples of such devices include, but are not limited to, one or more desktop computing devices, laptop computing devices, server computing devices, mobile computing devices, wearable devices, tablet computing devices, mobile telephones, smart phones, printers, displays, kiosks, vehicles, kitchen appliances, entertainment system devices, digital media players, and so on. The biometric payment system device 101 may include one more processing units 110 and/or other processors or controllers, non-transitory storage media 111 (which may take the form of, but is not limited to, a magnetic storage medium; optical storage medium; magneto-optical storage medium; read only memory; random access memory; erasable programmable memory; flash memory; and so on), communication units 112, and/or other components. The processing unit 110 may execute one or more sets of instructions stored in the non-transitory storage medium 111 to perform various functions, such as storing biometric data (which may include one or more hashes and/or other digital representations and/or derivations thereof of one or more fingerprints, blood vessel scans, palm-vein scans, voiceprints, facial images, retina images, iris images, deoxyribonucleic acid sequences, heart rhythms, gaits, and so on) and/or other identification information for people and associated identity information (such as one or more names, addresses, telephone numbers, financial data, financial account numbers, verified ages, insurance identifiers, payment account identifiers, medical proxies, and so on) in a data store (such as an identity system data store), receiving one or more digital representations of biometrics, matching one or more received digital representations of biometrics to stored biometric data, retrieving identity information associated with stored biometric data matching one or more received digital representations of biometrics, providing retrieved identity information, communicating with the payment instructing device 102 and/or the one or more other computing devices 104 (such as one or more merchant computing devices, one or more payment processor computing devices, one or more computing devices associated with one or more providers of one or more payment methods and/or loyalty programs, and so on) via the network 103 using the communication unit 112, and so on.

Similarly, the payment instructing device 102 may be any kind of electronic device and/or cloud and/or other computing arrangement. The payment instructing device 102 may include one or more processing units 113, communication units 114, non-transitory storage media 115, biometric reader devices 116 (such as a fingerprint scanner, a blood vessel scanner, a palm-vein scanner, an optical fingerprint scanner, a phosphorescent fingerprint scanner, a still image and/or video camera, a 2D and/or 3D image sensor, a capacitive sensor, a saliva sensor, a deoxyribonucleic acid sensor, a heart rhythm monitor, a microphone, and/or any device operable to capture distinctive biometric information from people), and so on. The processing unit 113 may execute one or more sets of instructions stored in the non-transitory storage medium 115 to perform various functions, such as obtaining one or more digital representations of one or more biometrics using the biometric reader device, communicate with the biometric payment system device 101 and/or the one or more other computing devices 104 via the network 103 using the communication unit 114, and so on.

Likewise, the one or more other computing devices 104 may be any kind of electronic device and/or cloud and/or other computing arrangement. Such other computing devices 104 may include one or more processing units, storage media, communication units, and/or other components. Various configurations are possible and contemplated without departing from the scope of the present disclosure.

Although the system 100 is illustrated and described as including particular components arranged in a particular configuration, it is understood that this is an example. In other implementations, other configurations of the same, similar, and/or different components may be used without departing from the scope of the present disclosure.

For example, the above describes optimizing the transaction as involving either selecting a set of payment methods to minimize cost, selecting a set of payment methods to maximize rewards, or selecting a loyalty program to use. However, it is understood that these are examples. In other examples, the system may determine both payment methods and loyalty programs, minimize cost and maximize reward and/or balance the two, determine payment methods and/or loyalty programs to use according to monitored past user behavior as opposed to minimized cost and/or maximized reward, and so on. Various configurations are possible and contemplated without departing from the scope of the present disclosure.

By way of another example, the above describes initiation of the transaction using the payment instructing device 102. However, it is understood that this is an example. In some implementations, the payment instructing device 102 may involve a number of cooperating devices (such as a point of sale device that communicates with the biometric payment system device 101, a personal electronic device that provides a digital representation of a biometric to a point of sale device that in turn communicates with the biometric payment system device 101, a personal electronic device that obtains transaction details to submit with a digital representation of a biometric to the biometric payment system device 101, and so on). Various configurations are possible and contemplated without departing from the scope of the present disclosure.

In yet another example, the above describes the biometric payment system device 101 determining the set of payment methods. However, in some examples, the biometric payment system device 101 may communicate with the payment instructing device 102 as part of such operations. For example, the set of payment methods may be presented to a person for confirmation or editing, the biometric payment system device 101 may prompt the person to optimize for a particular goal (such as minimized cost, maximized reward, and so on), and so on. Various configurations are possible and contemplated without departing from the scope of the present disclosure.

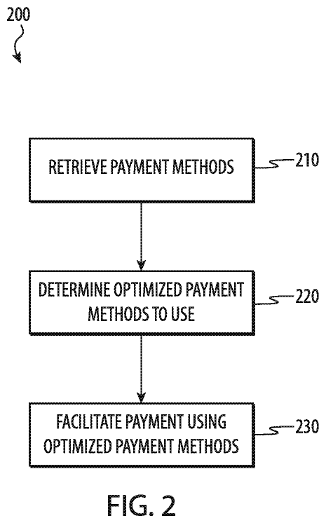

FIG. 2 is a flow chart illustrating a first example method 200 for intelligently optimizing transactions using a biometric payment system. This method 200 may be performed by the system 100 of FIG. 1.

At operation 210, an electronic device (such as the biometric payment system device 101 of FIG. 1) may retrieve one or more payment methods that are associated with identity information stored for a person. The payment methods may include multiple payment methods. The multiple payment methods may include at least one of a credit card identifier, a debit card identifier, an airline miles account identifier, a savings account identifier, a checking account identifier, an investment account identifier, cryptocurrency, or a loyalty account identifier.

At operation 220, the electronic device may determine optimized payment methods to use for one or more transactions. Determining optimized payment methods for the transaction may include determining a set of payment methods from the multiple payment methods that minimize a cost for the transaction, maximize a reward for the transaction, and so on. The set may include one of the multiple payment methods, a combination of the multiple payment methods, and so on.

At operation 230, the electronic device may facilitate payment using the optimized payment methods. Facilitating payment may include providing the set of payment methods to one or more merchant devices, submitting the set of payment methods to one or more payment processor devices, processing payment using the set of payment methods, and so on.

In various examples, this example method 200 may be implemented as a group of interrelated software modules or components that perform various functions discussed herein. These software modules or components may be executed within a cloud network and/or by one or more computing devices, such as the biometric payment system device 101 of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as optimizing payment methods for the transaction. However, in other examples, a loyalty program from a set of multiple loyalty programs may be determined to use for the transaction. Various configurations are possible and contemplated without departing from the scope of the present disclosure.

By way of another example, payment methods, loyalty programs, or other aspects may be optimized with considerations extending beyond a current transaction. By way of illustration, optimizing payment methods for a current transaction may involve using points in a rewards account to pay for a particular transaction. However, the rewards account may have status tiers related to current point levels and associated with different discounts. Use of the points in the rewards account for the particular transaction may change the status tier associated with the rewards account, and analysis may be performed of a transaction history may estimate that a person will likely soon make a purchase for which the person would have been eligible for a discount based on the current status tier, but not the changed tier. The possible discount may be taken into account to determine that although use of the points in the rewards account may optimize the current transaction, such use would involve a higher cost due to the loss of the discount for the upcoming transaction and a different payment method may instead be selected. Various configurations are possible and contemplated without departing from the scope of the present disclosure.

In still another example, characteristics of payment methods (such as rewards programs associated with credit cards) may change periodically and/or at other times. This may be taken into account. For example, a credit card may not be lowest cost for a particular transaction based on a current reward program tier, but the credit card may have rotating cash back program tiers that are due to change the next day whereupon the credit card would be the lowest cost. As such, the particular transaction may be delayed until the cash back program tier rotates and the credit card is the lowest cost option before using the credit card as the payment method for the particular transaction.

Alternatively, the credit card may be the lowest cost option before and after the cash back program tier rotates, but may be even lower cost after rotation. As such, the particular transaction may be delayed until the cash back program tier rotates before using the credit card as the payment method for the particular transaction. Various configurations are possible and contemplated without departing from the scope of the present disclosure.

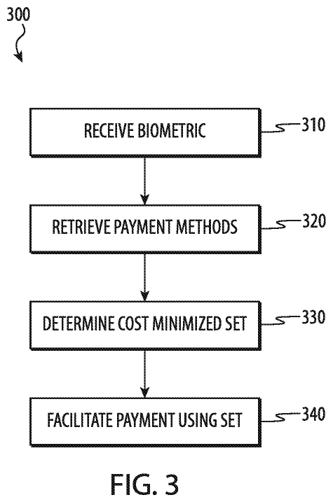

FIG. 3 is a flow chart illustrating a second example method 300 for intelligently optimizing transactions using a biometric payment system. This method 300 may be performed by the system 100 of FIG. 1.

At operation 310, an electronic device (such as the biometric payment system device 101 of FIG. 1) may receive one or more digital representations of one or more biometrics. The digital representation of the biometric may include one or more digital representations of one or more fingerprints, blood vessel scans, palm-vein scans, voiceprints, facial images, retina images, iris images, deoxyribonucleic acid sequences, heart rhythms, gaits, and so on obtained using one or more fingerprint scanners, blood vessel scanners, palm-vein scanners, optical fingerprint scanners, phosphorescent fingerprint scanners, still image and/or video cameras, 2D and/or 3D image sensors, capacitive sensors, saliva sensors, deoxyribonucleic acid sensors, heart rhythm monitors, microphones, and/or any devices operable to capture distinctive biometric information from people.

At operation 320, the electronic device may retrieve one or more payment methods. The payment methods may include multiple payment methods. For example, the digital representation of the biometric may be used to access a data store that associates biometric data with identity information. The payment methods may be included in and/or otherwise associated with the identity information.

At operation 330, the electronic device may determine a cost minimized set of the payment methods. The cost minimized set of the payment methods may be a set of one or more of the multiple payment methods that minimizes a cost for one or more transactions.

At operation 340, the electronic device may facilitate payment for the transaction using the cost minimized set of the payment methods. Facilitating payment may include providing the cost minimized set of the payment methods, processing payment using the cost minimized set of the payment methods, submitting information for the transaction and the cost minimized set of the payment methods to one or more payment processor devices, and so on.

In various examples, this example method 300 may be implemented as a group of interrelated software modules or components that perform various functions discussed herein. These software modules or components may be executed within a cloud network and/or by one or more computing devices, such as the biometric payment system device 101 of FIG. 1.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as determining a cost minimized set of the payment methods. However, in other examples, a set of payment methods other than a cost minimized set may be determined. For example, in some implementations, a reward maximized set may be determined. Various configurations are possible and contemplated without departing from the scope of the present disclosure.

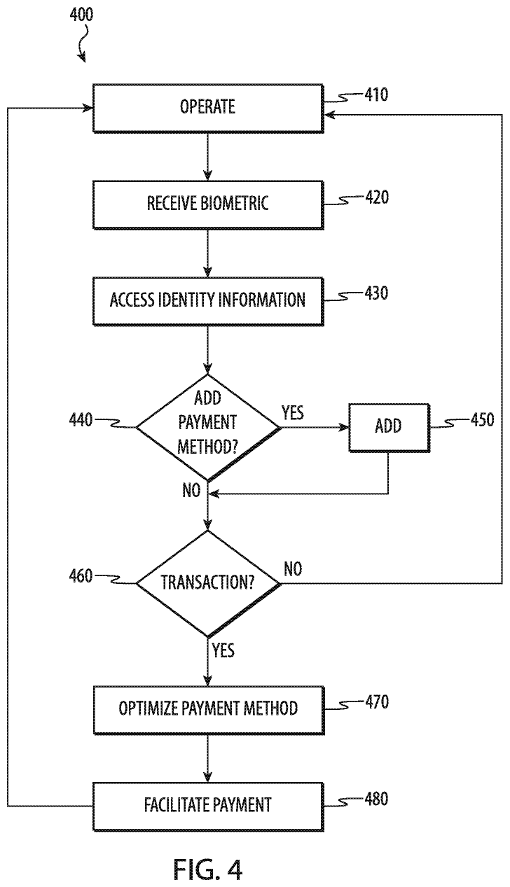

FIG. 4 is a flow chart illustrating a third example method 400 for intelligently optimizing transactions using a biometric payment system. This method 400 may be performed by the system 100 of FIG. 1.

At operation 410, an electronic device (such as the biometric payment system device 101 of FIG. 1) may operate. At operation 420, the electronic device may receive one or more digital representations of one or more biometrics for a person. At operation 430, the electronic device may access identity information for the person using the digital representation of the biometric.

At operation 440, the electronic device may determine whether or not to add a payment method. In some examples, the electronic device may determine to add the payment method in response to received user input indicating to add the payment method. In other examples, the electronic device may determine to add the payment method when there are currently no payment methods associated with the identity information and/or when previously associated payment methods are out of date. If so, the flow may proceed to operation 450 where the electronic device may add the payment method before the flow proceeds to operation 460. Otherwise, the flow may proceed directly to operation 460.

At operation 460, the electronic device may determine whether or not one or more requests associated with one or more transactions are received. If no, the flow may return to operation 410 where the electronic device may continue to operate. Otherwise, the flow may proceed to operation 470.

At operation 470, after the electronic device determines that one or more requests associated with one or more transactions are received, the electronic device may optimize payment methods for the transaction. The electronic device may optimize payment methods for the transaction by determining a set of payment methods from multiple payment methods that minimize a cost for the transaction, maximize a reward for the transaction, and so on.

At operation 480, the electronic device may facilitate payment for the transaction. The electronic device may facilitate payment for the transaction using the optimized payment methods.

In various examples, this example method 400 may be implemented as a group of interrelated software modules or components that perform various functions discussed herein. These software modules or components may be executed within a cloud network and/or by one or more computing devices, such as the biometric payment system device 101 of FIG. 1.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 is illustrated and described as determining whether or not to add one or more payment methods. However, it is understood that this is an example. In some implementations, this operation may be omitted. Various configurations are possible and contemplated without departing from the scope of the present disclosure.

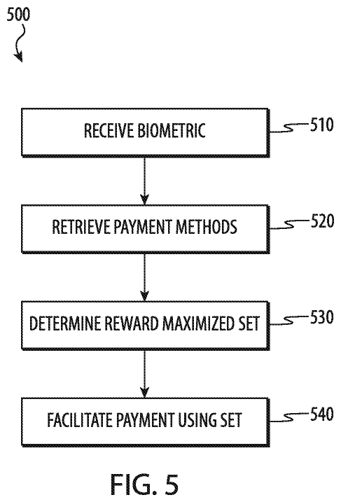

FIG. 5 is a flow chart illustrating a fourth example method 500 for intelligently optimizing transactions using a biometric payment system. This method 500 may be performed by the system 100 of FIG. 1.

At operation 510, an electronic device (such as the biometric payment system device 101 of FIG. 1) may receive one or more digital representations of one or more biometrics. At operation 520, the electronic device may retrieve one or more payment methods using the digital representation of the biometric. The payment methods may include multiple payment methods.

At operation 530, the electronic device may determine a reward maximized set of the payment methods. At operation 540, the electronic device may facilitate payment using the reward maximized set of the payment methods.

In various examples, this example method 500 may be implemented as a group of interrelated software modules or components that perform various functions discussed herein. These software modules or components may be executed within a cloud network and/or by one or more computing devices, such as the biometric payment system device 101 of FIG. 1.

Although the example method 500 is illustrated and described as including particular operations performed in a particular order, it is understood that this is an example. In various implementations, various orders of the same, similar, and/or different operations may be performed without departing from the scope of the present disclosure.

For example, the method 400 is illustrated and described as determining a reward maximized set of the payment methods. However, in other examples, a set of payment methods other than a reward maximized set may be determined. For example, in some implementations, a cost minimized set may be determined. Various configurations are possible and contemplated without departing from the scope of the present disclosure.

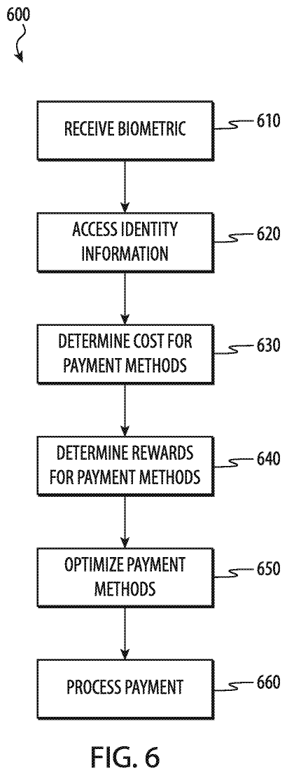

FIG. 6 is a flow chart illustrating a fifth example method 600 for intelligently optimizing transactions using a biometric payment system. This method 600 may be performed by the system 100 of FIG. 1.

At operation 610, an electronic device (such as the biometric payment system device 101 of FIG. 1) may receive one or more digital representations of one or more biometrics. At operation 620, the electronic device may access identity information using the digital representation of the biometric. The identity information may be associated with one or more payment methods, such as a group of multiple payment methods.

At operation 630, the electronic device may determine costs for the various multiple payment methods for a transaction. At operation 640, the electronic device may determine rewards for the various multiple payment methods for the transaction.

At operation 650, the electronic device may optimize the payment methods. Optimizing the payment methods may include determining a set of the multiple payment methods that minimizes a cost for the transaction, maximizes a reward for the transaction, balances minimizing the cost and maximizing the reward for the transaction, and so on.

At operation 660, the electronic device may process payment. Processing payment may include processing payment for the transaction using the optimized payment methods.

In various examples, this example method 600 may be implemented as a group of interrelated software modules or components that perform various functions discussed herein. These software modules or components may be executed within a cloud network and/or by one or more computing devices, such as the biometric payment system device 101 of FIG. 1.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as both determining costs and rewards for the multiple payment methods. However, it is understood that this is an example. In some implementations, one of these operations may be performed without performing the other. In a number of implementations, factors other than costs or rewards for the multiple payment methods may be determined. Various configurations are possible and contemplated without departing from the scope of the present disclosure.

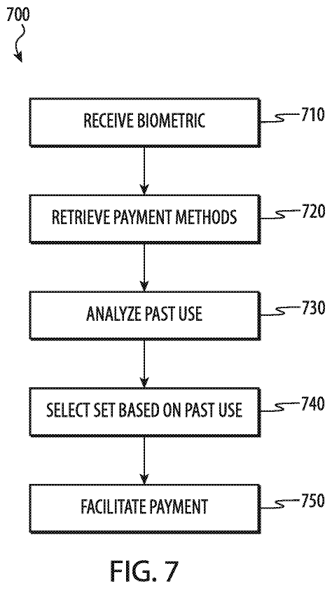

FIG. 7 is a flow chart illustrating a sixth example method 700 for intelligently optimizing transactions using a biometric payment system. This method 700 may be performed by the system 100 of FIG. 1.

At operation 710, an electronic device (such as the biometric payment system device 101 of FIG. 1) may receive one or more digital representations of one or more biometrics. At operation 720, the electronic device may retrieve a group of payment methods associated with the digital representation of the biometric, such as a group of payment methods associated with identity information that is also associated with the digital representation of the biometric.

At operation 730, the electronic device may analyze past use of the payment methods. For example, the electronic device may monitor a person's use of the payment methods, different criteria the person optimizes the payment methods for transactions, different situations in which the person selects different combinations of the payment methods, and so on.

At operation 740, the electronic device may select a set of the payment methods for a transaction based on the past use. At operation 750, the electronic device may facilitate payment for the transaction using the selected set of the payment methods.

In various examples, this example method 700 may be implemented as a group of interrelated software modules or components that perform various functions discussed herein. These software modules or components may be executed within a cloud network and/or by one or more computing devices, such as the biometric payment system device 101 of FIG. 1.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as determining a group of payment methods associated with a digital representation of a biometric. However, it is understood that this is an example. In other implementations, other mechanisms for determining an identity, identity information, and/or a corresponding group of payment methods may be used without reference to a digital representation of a biometric. Various configurations are possible and contemplated without departing from the scope of the present disclosure.

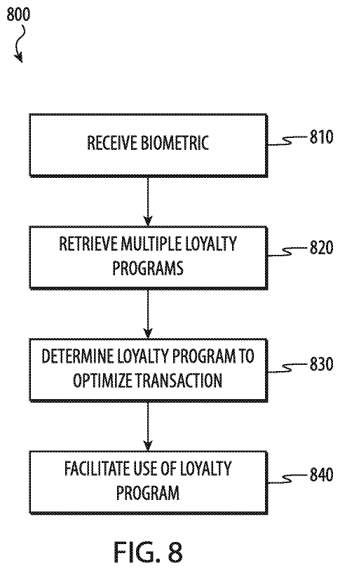

FIG. 8 is a flow chart illustrating a seventh example method 800 for intelligently optimizing transactions using a biometric payment system. This method 800 may be performed by the system 100 of FIG. 1.

At operation 810, an electronic device (such as the biometric payment system device 101 of FIG. 1) may receive one or more digital representations of one or more biometrics. At operation 820, the electronic device may retrieve multiple loyalty programs using identity information associated with the digital representation of the biometric.

At operation 830, the electronic device may determine a loyalty program to use to optimize one or more transactions. The electronic device may determine the loyalty program to use to optimize the transaction according to the loyalty program that will minimize a cost of the transaction, maximize a reward for the transaction, and so on. At operation 840, the electronic device may facilitate use of the loyalty program.

In various examples, this example method 800 may be implemented as a group of interrelated software modules or components that perform various functions discussed herein. These software modules or components may be executed within a cloud network and/or by one or more computing devices, such as the biometric payment system device 101 of FIG. 1.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 may include one or more additional operations. By way of illustration, in some implementations, the method 800 may also include optimizing payment methods for the transaction. Various configurations are possible and contemplated without departing from the scope of the present disclosure.

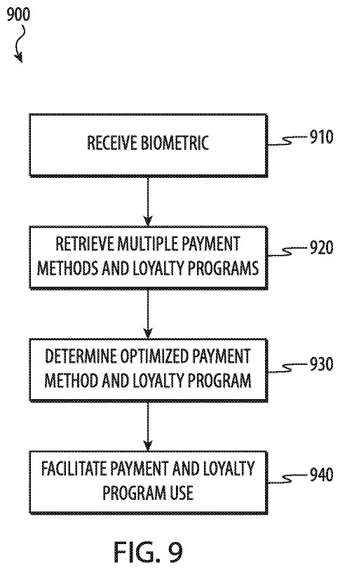

FIG. 9 is a flow chart illustrating an eighth example method 900 for intelligently optimizing transactions using a biometric payment system. This method 900 may be performed by the system 100 of FIG. 1.

At operation 910, an electronic device (such as the biometric payment system device 101 of FIG. 1) may receive one or more digital representations of one or more biometrics. At operation 920, the electronic device may retrieve multiple payment methods and loyalty programs associated with the digital representation of the biometric, such as multiple payment methods and loyalty programs associated with identity information that is also associated with the digital representation of the biometric.

At operation 930, the electronic device may determine optimized payment methods and loyalty programs for a transaction. The electronic device may determine optimized payment methods and loyalty programs to minimize a cost for the transaction, to maximize a reward for the transaction, to balance minimizing costs for the transaction with maximizing rewards for the transaction, and so on. At operation 940, the electronic device may facilitate payment and loyalty program use. The electronic device may facilitate payment and loyalty program use by using the optimized payment methods and loyalty programs for the transaction.

In various examples, this example method 900 may be implemented as a group of interrelated software modules or components that perform various functions discussed herein. These software modules or components may be executed within a cloud network and/or by one or more computing devices, such as the biometric payment system device 101 of FIG. 1.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 is illustrated and described as optimizing both payment methods and loyalty programs for the transaction. However, it is understood that this is an example. In other implementations, one or more of these operations may be omitted and/or replaced with one or more other operations. Various configurations are possible and contemplated without departing from the scope of the present disclosure.

In various implementations, a biometric payment system that intelligently optimizes transactions may include at least one non-transitory storage medium that stores instructions and at least one processing unit. The at least one processing unit may execute the instructions to receive a digital representation of a biometric for a person in association with a transaction, access identity information for the person using the digital representation of the biometric, retrieve multiple payment methods from the identity information, use at least the identity information to determine a set of the multiple payment methods for the transaction that minimizes a cost to the person, and facilitate payment for the transaction using the set of the multiple payment methods.

In some examples, the set of the multiple payment methods may include one of the multiple payment methods. In other implementations, the set of the multiple payment methods may include a combination of the multiple payment methods. In various examples, the multiple payment methods may include at least one of a credit card identifier, a debit card identifier, an airline miles account identifier, a savings account identifier, a checking account identifier, an investment account identifier, cryptocurrency, or a loyalty account identifier.

In a number of examples, the at least one processing unit may facilitate the payment for the transaction by providing the set of the multiple payment methods to a merchant device associated with the transaction. In some examples, the at least one processing unit may facilitate the payment for the transaction by processing the payment using the set of the multiple payment methods. In a number of examples, the at least one processing unit may facilitate the payment for the transaction by submitting at least a portion of the set of the multiple payment methods to at least one payment processing device.

In some implementations, a biometric payment system that intelligently optimizes transactions may include at least one non-transitory storage medium that stores instructions and at least one processing unit. The at least one processing unit may execute the instructions to receive a digital representation of a biometric for a person in association with a transaction, access identity information for the person using the digital representation of the biometric, retrieve multiple payment methods from the identity information, use at least the identity information to determine a set of the multiple payment methods for the transaction that maximizes a reward for the person for using the set of the multiple payment methods, and facilitate payment for the transaction using the set of the multiple payment methods.

In various examples, the at least one processing unit may receive transaction details for the transaction and use the transaction details and the identity information to determine the set of the multiple payment methods. In some implementations of such examples, at least one of the multiple payment methods may provide variable rewards corresponding to different transaction details.

In a number of examples, the at least one processing unit may receive payment method information from at least one payment method provider associated with at least one of the multiple payment methods and use the payment method information and the identity information to determine the set of the multiple payment methods. In various examples, the reward may include at least one of a cash back program benefit, a loyalty reward point, a rewards tier increment, or a discount.

In some examples, the at least one processing unit may facilitate the payment for the transaction by communicating with at least one payment method provider associated with at least one of the set of the multiple payment methods. In various implementations of such examples, the at least one processing unit may provide information regarding the transaction to the at least one payment method provider.

In a number of implementations, a biometric payment system that intelligently optimizes transactions may include at least one non-transitory storage medium that stores instructions and at least one processing unit. The at least one processing unit may execute the instructions to receive a digital representation of a biometric for a person in association with a transaction, access identity information for the person using the digital representation of the biometric, retrieve multiple loyalty programs from the identity information, use at least the identity information to determine a loyalty program of the multiple loyalty programs to use for the transaction that optimizes the transaction for the person, and facilitate use of the loyalty program for the transaction.

In some examples, the loyalty program of the multiple loyalty programs may be a first loyalty program, the multiple loyalty programs may include a second loyalty program, and the first loyalty program may optimize the transaction for the person by resulting in a lower cost than the second loyalty program. In various examples, the loyalty program of the multiple loyalty programs may be a first loyalty program, the multiple loyalty programs may include a second loyalty program, and the first loyalty program may optimize the transaction for the person by resulting in a greater reward than the second loyalty program.

In a number of examples, the at least one processing unit may facilitate payment for the transaction. In some examples, the at least one processing unit may maintain the loyalty program for a loyalty program provider. In various examples, the at least one processing unit may enroll the person in the loyalty program.

Although the above illustrates and describes a number of embodiments, it is understood that these are examples. In various implementations, various techniques of individual embodiments may be combined without departing from the scope of the present disclosure.

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

As described above and illustrated in the accompanying figures, the present disclosure relates to a biometric payment system that intelligently optimizes transactions. The system may receive one or more digital representations of one or more biometrics for one or more people, access associated identity information, and use the identity information to optimize one or more transactions. This optimization may involve determining one or more payment methods that minimize a cost of the transaction, determining one or more payment methods that maximize a reward for the transaction, determining one or more loyalty programs to minimize cost and/or maximize reward for the transaction, and so on.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A biometric payment system that intelligently optimizes transactions, comprising:
at least one non-transitory storage medium that stores instructions; and
at least one processing unit that executes the instructions to:
receive a digital representation of a biometric for a person in association with a transaction;
access identity information for the person using the digital representation of the biometric;
retrieve multiple payment methods from the identity information;
use at least the identity information to determine a set of the multiple payment methods for the transaction that minimizes a cost to the person;
facilitate payment for the transaction using the set of the multiple payment methods;
determine that delaying the payment for the transaction minimizes the cost to the person; and
delay the payment for the transaction.

2. The biometric payment system of claim 1, wherein the set of the multiple payment methods includes one of the multiple payment methods.

3. The biometric payment system of claim 1, wherein the set of the multiple payment methods includes a combination of the multiple payment methods.

4. The biometric payment system of claim 1, wherein the set of the multiple payment methods includes at least one of:
a credit card identifier;
a debit card identifier;
an airline miles account identifier;
a savings account identifier;
a checking account identifier;
an investment account identifier;
cryptocurrency; or
a loyalty account identifier.

5. The biometric payment system of claim 1, wherein the at least one processing unit facilitates the payment for the transaction by providing the set of the multiple payment methods to a merchant device associated with the transaction.

6. The biometric payment system of claim 1, wherein the at least one processing unit facilitates the payment for the transaction by processing the payment using the set of the multiple payment methods.

7. The biometric payment system of claim 1, wherein the at least one processing unit facilitates the payment for the transaction by submitting at least a portion of the set of the multiple payment methods to at least one payment processing device.

8-20. (canceled)

21. The biometric payment system of claim 1, wherein the at least one processing unit:
receives transaction details for the transaction; and
uses the transaction details and the identity information to determine the set of the multiple payment methods.

22. The biometric payment system of claim 21, wherein at least one of the multiple payment methods involves different costs corresponding to different transaction details.

23. The biometric payment system of claim 1, wherein the at least one processing unit:
receives payment method information from at least one payment method provider associated with at least one of the multiple payment methods; and
uses the payment method information and the identity information to determine the set of the multiple payment methods.

24. The biometric payment system of claim 1, wherein the at least one processing unit facilitates the payment for the transaction by communicating with at least one payment method provider associated with at least one of the set of the multiple payment methods.

25. The biometric payment system of claim 24, wherein the at least one processing unit provides information regarding the transaction to the at least one payment method provider.

26. The biometric payment system of claim 1, wherein the at least one processing unit maintains a loyalty program for a loyalty program provider.

27. The biometric payment system of claim 26, wherein the loyalty program comprises one of the set of the multiple payment methods.

28. The biometric payment system of claim 1, wherein the at least one processing unit determines that delaying the payment for the transaction minimizes the cost to the person because one of the set of the multiple payment methods has a different cost prior to and after the delay.

29. The biometric payment system of claim 28, wherein a cash back program tier rotates after the delay.

30. A biometric payment system that intelligently optimizes transactions, comprising:
at least one non-transitory storage medium that stores instructions; and
at least one processing unit that executes the instructions to:
access identity information for a person using a digital representation of a biometric for the person obtained in association with a transaction;
use at least the identity information to determine a set of multiple payment methods for the transaction that minimizes a cost to the person, each of the set of multiple payment methods identified using the identity information;
facilitate payment for the transaction using the set of multiple payment methods;
determine that delaying the payment for the transaction minimizes the cost because one of the set of multiple payment methods has a first cost prior to the delay and a second cost that is lower than the first cost after the delay; and
delays the payment for the transaction.

31. The biometric payment system of claim 30, wherein the set of multiple payment methods includes an airline miles account identifier.

32. A biometric payment system that intelligently optimizes transactions, comprising:
at least one non-transitory storage medium that stores instructions; and
at least one processing unit that executes the instructions to:
determine a set of multiple payment methods for a transaction that minimizes a cost to a person, payment methods of the set of multiple payment methods identified using identity information for the person that is accessed using a digital representation of a biometric for the person that is obtained in association with the transaction;
facilitate payment for the transaction using the set of multiple payment methods; and
maintain a loyalty program for a loyalty program provider.

33. The biometric payment system of claim 32, wherein the set of multiple payment methods includes at least two payment methods of the set of multiple payment methods.
